(19) United States
(12) Patent Application Publication
(10) Pub. No.: US 2008/0238307 A1
(43) Pub. Date: Oct. 2, 2008

(54) ORGANIC ELECTROLUMINESCENCE ELEMENT

(76) Inventors: Manabu TOBISE, Kanagawa (JP); Hirofumi Fukunaga, Kanagawa (JP)

Correspondence Address: BIRCH STEWART KOLASCH & BIRCH, PO BOX 747, FALLS CHURCH, VA, 22040-0747, US

(21) Appl. No.: 12/054,210

(22) Filed: Mar. 24, 2008

(30) Foreign Application Priority Data
Mar. 26, 2007 (JP) 2007-080254

(51) Int. Cl. H01J 1/63

(52) U.S. Cl. 313/504

(57) ABSTRACT

An organic electroluminescence element is disclosed, which includes at least one organic compound layer including a light-emitting layer between a pair of electrodes, wherein the light-emitting layer contains a host material, a light-emitting material and a phosphine oxide compound. An organic electroluminescence element exhibiting high light-emission efficiency and having excellent drive durability is provided.

### CROSS-REFERENCE TO RELATED APPLICATION

This application claims priority under 35 USC 119 from Japanese Patent Application No. 2007-080,254, the disclosure of which is incorporated by reference herein.

### BACKGROUND OF THE PRESENT INVENTION

1. Field of the Present Invention

The present invention relates to an organic electroluminescence element (hereinafter, referred to as an “organic EL element” in some cases) which can be effectively applied to a surface light source for full color displays, backlights, illumination light sources and the like; or a light source array for printers, and the like.

2. Description of the Related Art

An organic EL element is composed of a light-emitting layer or a plurality of organic layers containing a light-emitting layer, and a pair of electrodes sandwiching the organic layers. The organic EL element is a device for obtaining luminescence by utilizing at least either one of luminescence from excitons each of which is obtained by recombining an electron injected from a cathode with a hole injected from an anode to produce an exciton in the organic layer, or luminescence from excitons of other molecules produced by energy transmission from the above-described excitons, Heretofore, an organic EL element has been developed by using a laminate structure from integrated layers in which each layer is functionally differentiated, whereby the brightness and the device efficiency are remarkably improved. For example, a two-layer laminated type device obtained by laminating a hole transport layer and a light-emitting layer also functioning as an electron transport layer; a three-layer laminated type device obtained by laminating a hole transport layer, a light-emitting layer, and an electron transport layer; and a four-layer laminated type device obtained by laminating a hole transport layer, a light-emitting layer, a hole-blocking layer, and an electron transport layer have been frequently used.

For the practical application of an organic EL element, however, there are still many problems such as improvement in light-emission efficiency and drive durability. Particularly, increase in light-emission efficiency results in a decrease in power consumption, and further, it is advantageous in view of drive durability. Accordingly, many means of improvement have been heretofore disclosed. However, a light-emitting material having a high light-emission efficiency usually has a disadvantage of causing brightness deterioration during driving thereof, and further, a material excellent in drive durability involves a disadvantage of low brightness. Accordingly, it is not easy to achieve both higher light-emission efficiency and higher drive durability, and thus, further improvements are sought.

Japanese Patent Application Laid-Open (JP-A) No. 2005-123164, for example, discloses an organic EL element improved in light-emission efficiency which contains an electron-transporting material, a hole-transporting material and a dopant as a light-emitting material in a light-emitting layer. However, an electron transportation property and a hole transportation property of the electron-transporting material, serving as a host, and the hole-transporting material, respectively, are insufficient, and therefore, improvement in light-emission efficiency and reduction in drive power have not yet been obtained to the degree that was expected.

On the other hand, light-emitting materials having a high light-emission efficiency also are sought. For example, JP-A No. 2002-63989 and “New Charge Transporting Host Material for Short Wavelength Organic Electrophosphorescence: 2,7-Bis(diphenylphosphine oxide)-9,9-dimethyl-fluorene”, Chem. Mater., vol. 18, pages 2389 to 2396 (2006) disclose that phosphine oxide compounds are excellent in electron injection property and transportation property, and that, accordingly, improvement in light-emission efficiency and lowering of drive voltage may be expected due to the use of those compounds in a light-emitting layer. However, there is a problem in that, when a phosphine oxide compound is used as a host material of a light-emitting layer, drive durability is significantly degraded because the phosphine oxide compound deteriorates during continuous driving to lose the function as a host material.

Accordingly, the development of an organic EL element that has a high light-emission efficiency and is excellent in drive durability is needed.

### SUMMARY OF THE INVENTION

The present invention has been made in view of the above circumstances and provides an organic electroluminescence element comprising at least one organic compound layer comprising a light-emitting layer between a pair of electrodes, wherein the light-emitting layer comprises a host material and a light-emitting material, and further comprises a phosphine oxide compound.

### DETAILED DESCRIPTION OF THE INVENTION

A purpose of the present invention is to provide an organic EL element that exhibits high light-emission efficiency and is excellent in drive durability.

The present invention has been made in view of the above circumstances, and objects of the invention have been achieved by the following means.

The organic electroluminescence element of the present invention is an organic electroluminescence element comprising at least one organic compound layer comprising a light-emitting layer between a pair of electrodes, wherein the light-emitting layer comprises a host material and a light-emitting material, and further comprises a phosphine oxide compound.

Preferably, the phosphine oxide compound has an ionization potential (Ip value) larger than an Ip value of at least one of the host material or the light-emitting material.

Preferably, a content of the phosphine oxide compound in the light-emitting layer is from 5% by weight to 50% by weight based on a total solid content of the light-emitting layer, and more preferably from 15% by weight to 30% by weight.

Preferably, the organic electroluminescence element further comprises an organic layer comprising a phosphine oxide compound on a cathode side of the light-emitting layer, and a hole-blocking layer between the organic layer and the light-emitting layer.

Preferably, the phosphine oxide compound contained in the light-emitting layer or the organic layer is a compound represented by the following formula (I).

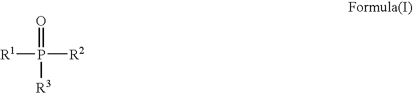

In formula (I), R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

Preferably, the phosphine oxide compound represented by the formula (I) is a compound represented by the following formula (II).

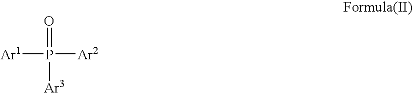

In formula (II), Ar¹, Ar² and Ar³ each independently represent an aryl group or a heterocyclic group.

In another preferable embodiment, the phosphine oxide compound is a compound represented by the following formula (III).

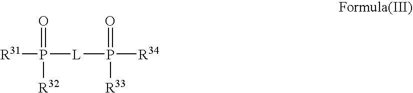

In formula (III), R³¹ to R³⁴ each independently represent an aryl group or a heterocyclic group, and L represents a divalent linking group.

By the present invention, an organic EL element having a high light-emission efficiency and an excellent drive durability is provided.

Hereinafter, the organic EL element of the invention is described in detail.

The light-emitting element of the invention has a cathode and an anode on a substrate, and at least one organic compound layer including an organic light-emitting layer (hereinafter, sometimes simply referred to as a “light-emitting layer”) between the two electrodes. Due to the nature of a light-emitting element, at least one electrode of the anode and the cathode is preferably transparent.

The organic compound layer in the invention may be either of a monolayer or an integrated layer. In the case of an integrated layer, a preferable embodiment has a hole transport layer, a light-emitting layer and an electron transport layer integrated in this order from the anode side. In addition, a charge-blocking layer or the like may be provided between the hole transport layer and the light-emitting layer, or between the light-emitting layer and the electron transport layer. A hole injection layer may be provided between the anode and the hole transport layer. An electron injection layer may be disposed between the cathode and the electron transport layer. Further, each of the layers may be composed of plural secondary layers.

### 1. Description of the Phosphine Oxide Compound

Next, the phosphine oxide compound for use in the organic electroluminescence element of the invention is described in detail.

The phosphine oxide compound for use in the invention is preferably a compound represented by the following formula (I).

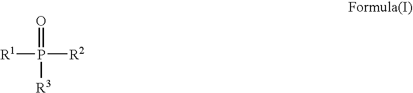

In formula (I), R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

More preferably, the phosphine oxide compound for use in the invention is a compound represented by the following formula (II).

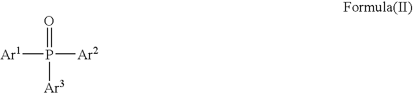

In formula (II), Ar¹, Ar² and Ar³ each independently represent an aryl group or a heterocyclic group.

Still another group of preferable phosphine oxide compounds in the invention is a group of compounds represented by the following formula (III).

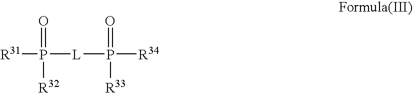

In formula (III), R³¹ to R³⁴ each independently represent an aryl group or a heterocyclic group. L represents a divalent linking group.

Formula (I) is described in detail.

Each of R¹, R² and R³ is an alkyl group (having preferably 1 to 30 carbon atoms, more preferably 1 to 20 carbon atoms, and particularly preferably 1 to 10 carbon atoms, including, for example, methyl, ethyl, iso-propyl, tert-butyl, n-octyl, n-decyl, n-hexadecyl, cyclopropyl, cyclopentyl, cyclohexyl and the like), an alkenyl group (having preferably 2 to 30 carbon atoms, more preferably 2 to 20 carbon atoms, and particularly preferably 2 to 10 carbon atoms, including, for example, vinyl, allyl, 2-butenyl, 3-pentenyl and the like), an alkynyl group (having preferably 2 to 30 carbon atoms, more preferably 2 to 20 carbon atoms, and particularly preferably 2 to 10 carbon atoms, including, for example, propargyl, 3-pentynyl and the like), an aryl group (having preferably 6 to 30 carbon atoms, more preferably 6 to 20 carbon atoms, and particularly preferably 6 to 12 carbon atoms, including, for example, phenyl, p-methylphenyl, naphthyl, anthryl and the like), an amino group (having preferably 0 to 30 carbon atoms, more preferably 0 to 20 carbon atoms, and particularly preferably 0 to 10 carbon atoms, including, for example, amino, methylamino, dimethylamino, diethylamino, dibenzyl amino, diphenylamino, ditolylamino and the like), an alkoxy group (having preferably 1 to 30 carbon atoms, more preferably 1 to 20 carbon atoms, and particularly preferably 1 to 10 carbon atoms, including, for example, methoxy, ethoxy, butoxy, 2-ethylhexyloxy and the like), an aryloxy group (having preferably 6 to 30 carbon atoms, more preferably 6 to 20 carbon atoms, and particularly preferably 6 to 12 carbon atoms, including, for example, phenyloxy, 1-naphthyloxy, 2-naphthyloxy and the like), a heterocyclic oxy group (having preferably 1 to 30 carbon atoms, more preferably 1 to 20 carbon atoms, and particularly preferably 1 to 12 carbon atoms, including, for example, pyridyloxy, pyrazyloxy, pyrimidyloxy, quinolyloxy and the like), an acyl group (having preferably 1 to 30 carbon atoms, more preferably 1 to 20 carbon atoms, and particularly preferably 1 to 12 carbon atoms, including, for example, acetyl, benzoyl, formyl, pivaloyl and the like), an alkoxycarbonyl group (having preferably 2 to 30 carbon atoms, more preferably 2 to 20 carbon atoms, and particularly preferably 2 to 12 carbon atoms, including, for example, methoxycarbonyl, ethoxycarbonyl and the like), an aryloxycarbonyl group (having preferably 7 to 30 carbon atoms, more preferably 7 to 20 carbon atoms, and particularly preferably 7 to 12 carbon atoms, including, for example, phenyloxycarbonyl and the like), an acyloxy group (having preferably 2 to 30 carbon atoms, more preferably 2 to 20 carbon atoms, and particularly preferably 2 to 10 carbon atoms, including, for example, acetoxy, benzoyloxy and the like), an acylamino group (having preferably 2 to 30 carbon atoms, more preferably 2 to 20 carbon atoms, and particularly preferably 2 to 10 carbon atoms, including, for example, acetylamino, benzoylamino and the like), an alkoxycarbonylamino group (having preferably 2 to 30 carbon atoms, more preferably 2 to 20 carbon atoms, and particularly preferably 2 to 12 carbon atoms, including, for example, methoxycarbonylamino and the like), an aryloxycarbonylamino group (having preferably 7 to 30 carbon atoms, more preferably 7 to 20 carbon atoms, and particularly preferably 7 to 12 carbon atoms, including, for example, phenyloxycarbonylamino and the like), a sulfonylamino group (having preferably 1 to 30 carbon atoms, more preferably 1 to 20 carbon atoms, and particularly preferably 1 to 12 carbon atoms, including, for example, methanesulfonylamino, benzenesulfonylamino and the like), a sulfamoyl group (having preferably 0 to 30 carbon atoms, more preferably 0 to 20 carbon atoms, and particularly preferably 0 to 12 carbon atoms, including, for example, sulfamoyl, methylsulfamoyl, dimethylsulfamoyl, phenylsulfamoyl and the like), a carbamoyl group (having preferably 1 to 30 carbon atoms, more preferably 1 to 20 carbon atoms, and particularly preferably 1 to 12 carbon atoms, including, for example, carbamoyl, methylcarbamoyl, diethylcarbamoyl, phenylcarbamoyl and the like), an alkylthio group (having preferably 1 to 30 carbon atoms, more preferably 1 to 20 carbon atoms, and particularly preferably 1 to 12 carbon atoms, including, for example, methylthio, ethylthio and the like), an arylthio group (having preferably 6 to 30 carbon atoms, more preferably 6 to 20 carbon atoms, and particularly preferably 6 to 12 carbon atoms, including, for example, phenylthio and the like), a heterocyclic thio group (having preferably 1 to 30 carbon atoms, more preferably 1 to 20 carbon atoms, and particularly preferably 1 to 12 carbon atoms, including, for example, pyridylthio, 2-benzimidazolylthio, 2-benzoxazolylthio, 2-benzthiazolylthio and the like), a heterocyclic group (having preferably 1 to 30 carbon atoms, and more preferably 1 to 12 carbon atoms, which contains, for example, a nitrogen atom, an oxygen atom, or a sulfur atom as a hetero atom, including, more specifically, an imidazolyl, pyridyl, quinolyl, furyl, thienyl, piperidyl, morpholino, benzoxazolyl, benzimidazolyl, benzthiazolyl, carbazolyl, azepinyl and the like).

Groups represented by R¹, R² and R³ may be the same or different from each other. The groups represented by R¹, R² and R³ are preferably an alkyl group, an alkenyl group, an alkynyl group, an aryl group or a heterocyclic group, more preferably an alkyl group, an aryl group or a heterocyclic group, and particularly preferably an aryl group or a heterocyclic group.

Each of the groups represented by R¹, R² and R³ may further have a substituent. Examples of applicable substituents include an alkyl group (having preferably 1 to 30 carbon atoms, more preferably 1 to 20 carbon atoms, and particularly preferably 1 to 10 carbon atoms, including, for example, methyl, ethyl, iso-propyl, tert-butyl, n-octyl, n-decyl, n-hexadecyl, cyclopropyl, cyclopentyl, cyclohexyl and the like), an alkenyl group (having preferably 2 to 30 carbon atoms, more preferably 2 to 20 carbon atoms, and particularly preferably 2 to 10 carbon atoms, including, for example, vinyl, allyl, 2-butenyl, 3-pentenyl and the like), an alkynyl group (having preferably 2 to 30 carbon atoms, more preferably 2 to 20 carbon atoms, and particularly preferably 2 to 10 carbon atoms, including, for example, propargyl, 3-pentynyl and the like), an aryl group (having preferably 6 to 30 carbon atoms, more preferably 6 to 20 carbon atoms, and particularly preferably 6 to 12 carbon atoms, including, for example, phenyl, p-methylphenyl, naphthyl, anthryl and the like), an amino group (having preferably 0 to 30 carbon atoms, more preferably 0 to 20 carbon atoms, and particularly preferably 0 to 10 carbon atoms, including, for example, amino, methylamino, dimethylamino, diethylamino, dibenzylamino, diphenylamino, ditolylamino and the like), an alkoxy group (having preferably 1 to 30 carbon atoms, more preferably 1 to 20 carbon atoms, and particularly preferably 1 to 10 carbon atoms, including, for example, methoxy, ethoxy, butoxy, 2-ethylhexyloxy and the like), an aryloxy group (having preferably 6 to 30 carbon atoms, more preferably 6 to 20 carbon atoms, and particularly preferably 6 to 12 carbon atoms, including, for example, phenyloxy, 1-naphthyloxy, 2-naphthyloxy and the like), a heterocyclic oxy group (having preferably 1 to 30 carbon atoms, more preferably 1 to 20 carbon atoms, and particularly preferably 1 to 12 carbon atoms, including, for example, pyridyloxy, pyrazyloxy, pyrimidyloxy, quinolyloxy and the like), an acyl group (having preferably 1 to 30 carbon atoms, more preferably 1 to 20 carbon atoms, and particularly preferably 1 to 12 carbon atoms, including, for example, acetyl, benzoyl, formyl, pivaloyl and the like), an alkoxycarbonyl group (having preferably 2 to 30 carbon atoms, more preferably 2 to 20 carbon atoms, and particularly preferably 2 to 12 carbon atoms, including, for example, methoxycarbonyl, ethoxycarbonyl and the like), an aryloxycarbonyl group (having preferably 7 to 30 carbon atoms, more preferably 7 to 20 carbon atoms, and particularly preferably having 7 to 12 carbon atoms, including, for example, phenyloxycarbonyl and the like), an acyloxy group (having preferably 2 to 30 carbon atoms, more preferably 2 to 20 carbon atoms, and particularly preferably 2 to 10 carbon atoms, including, for example, acetoxy, benzoyloxy and the like), an acylamino group (having preferably 2 to 30 carbon atoms, more preferably 2 to 20 carbon atoms, and particularly preferably 2 to 10 carbon atoms, including, for example, acetylamino, benzoylamino and the like), an alkoxycarbonylamino group (having preferably 2 to 30 carbon atoms, more preferably 2 to 20 carbon atoms, and particularly preferably 2 to 12 carbon atoms, including, for example, methoxycarbonylamino and the like), an aryloxycarbonylamino group (having preferably 7 to 30 carbon atoms, more preferably 7 to 20 carbon atoms, and particularly preferably 7 to 12 carbon atoms, including, for example, phenyloxycarbonylamino and the like), a sulfonylamino group (having preferably 1 to 30 carbon atoms, more preferably 1 to 20 carbon atoms, and particularly preferably 1 to 12 carbon atoms, including, for example, methanesulfonylamino, benzenesulfonylamino and the like), a sulfamoyl group (having preferably 0 to 30 carbon atoms, more preferably 0 to 20 carbon atoms, and particularly preferably 0 to 12 carbon atoms, including, for example, sulfamoyl, methylsulfamoyl, dimethylsulfamoyl, phenylsulfamoyl and the like), a carbamoyl group (having preferably 1 to 30 carbon atoms, more preferably 1 to 20 carbon atoms, and particularly preferably 1 to 12 carbon atoms, including, for example, carbamoyl, methylcarbamoyl, diethylcarbamoyl, phenylcarbamoyl and the like), an alkylthio group (having preferably 1 to 30 carbon atoms, more preferably 1 to 20 carbon atoms, and particularly preferably 1 to 12 carbon atoms, including, for example, methylthio, ethylthio and the like), an arylthio group (having preferably 6 to 30 carbon atoms, more preferably 6 to 20 carbon atoms, and particularly preferably 6 to 12 carbon atoms, including, for example, phenylthio and the like), a heterocyclic thio group (having preferably 1 to 30 carbon atoms, more preferably 1 to 20 carbon atoms, and particularly preferably 1 to 12 carbon atoms, including, for example, pyridylthio, 2-benzimidazolylthio, 2-benzoxazolylthio, 2-benzthiazolylthio and the like), a sulfonyl group (having preferably 1 to 30 carbon atoms, more preferably 1 to 20 carbon atoms, and particularly preferably 1 to 12 carbon atoms, including, for example, mesyl, tosyl and the like), a sulfinyl group (having preferably 1 to 30 carbon atoms, more preferably 1 to 20 carbon atoms, and particularly preferably 1 to 12 carbon atoms, including, for example, methanesulfinyl, benzenesulfinyl and the like), a ureido group (having preferably 1 to 30 carbon atoms, more preferably 1 to 20 carbon atoms, and particularly preferably 1 to 12 carbon atoms, including, for example, ureido, methylureido, phenylureido and the like), a phosphoric amido group (having preferably 1 to 30 carbon atoms, more preferably 1 to 20 carbon atoms, and particularly preferably 1 to 12 carbon atoms, including, for example, diethyl phosphoric amido, phenyl phosphoric amido and the like), a hydroxy group, a mercapto group, a fluoro group, a chloro group, a bromo group, an iodo group, a cyano group, a sulfo group, a carboxy group, a nitro group, a hydroxamic acid group, a sulfino group, a hydrazino group, an imino group, a heterocyclic group (having preferably 1 to 30 carbon atoms, and more preferably 1 to 12 carbon atoms, which contains, for example, a nitrogen atom, an oxygen atom or a sulfur atom as a hetero atom, including, specifically, imidazolyl, pyridyl, quinolyl, furyl, thienyl, piperidyl, morpholino, benzoxazolyl, benzimidazolyl, benzthiazolyl, carbazolyl, azepinyl and the like), a silyl group (having preferably 3 to 40 carbon atoms, more preferably 3 to 30 carbon atoms, and particularly preferably 3 to 24 carbon atoms, including, for example, trimethylsilyl, triphenylsilyl and the like), a silyloxy group (having preferably 3 to 40 carbon atoms, more preferably 3 to 30 carbon atoms, and particularly preferably 3 to 24 carbon atoms, including, for example, trimethylsilyloxy, triphenylsilyloxy and the like), and a phosphoryl group (including, for example, diphenylphosphoryl, dimethylphosphoryl and the like).

The substituent held by the group represented by R¹, R² or R³ is preferably an alkyl group, an alkenyl group, an alkynyl group, an aryl group, an amino group, an alkoxy group, an aryloxy group, a heterocyclic oxy group, an alkylthio group, an arylthio group, a heterocyclic thio group, a sulfonyl group, a sulfinyl group, a fluoro group, a chloro group, a bromo group, an iodo group, a cyano group, a heterocyclic group, a silyl group, a silyloxy group or a phosphoryl group, more preferably an alkyl group, an alkenyl group, an aryl group, an amino group, an alkoxy group, an aryloxy group, a heterocyclic oxy group, a sulfonyl group, a fluoro group, a cyano group, a heterocyclic group, a silyl group, a silyloxy group or a phosphoryl group, even more preferably an alkyl group, an aryl group, an amino group, a fluoro group, a cyano group, a heterocyclic group, a silyl group or a phosphoryl group, and further preferably an alkyl group, an aryl group, a cyano group, a heterocyclic group or a phosphoryl group.

Compounds represented by formula (I) are more preferably compounds represented by the following formula (II):

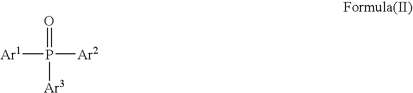

In the formula, Ar¹, Ar² and Ar³ each independently represent an aryl group or a heterocyclic group.

Next, formula (II) is described in detail.

In the formula, Ar¹, Ar² and Ar³ each independently represent a substituted or unsubstituted aryl group or heterocyclic group. Specific examples of the aryl group represented by Ar¹, Ar² or Ar³ include a phenyl group, a naphthyl group, an anthryl group, a phenanthryl group, a pyrenyl group, a perylenyl group, a fluoranthenyl group, a fluorenyl group, a chrysenyl group, a tetracenyl group, a pentacenyl group, a triphenylenyl group, a tetraphenylenyl group and the like. These aryl groups may have a substituent. As the substituent, those mentioned as a substituent held by the groups represented by R¹, R² and R³ in formula (I) can be applied, which also have a similar preferable range.

Specific examples of the heteroaryl group represented by Ar¹, Ar² or Ar³ include a pyridyl group, a pyrazinyl group, a triazinyl group, a pyrimidinyl group, a pyridazinyl group, a quinolyl group, a quinoxalinyl group, a phthalazinyl group, a quinazolinyl group, a cinnolinyl group, a isoquinolyl group, an acridinyl group, a phenanthridinyl group, a phenanthrolinyl group, a pteridinyl group, an imidazopyridyl group, a pyrrolyl group, an indolyl group, a pyrazolyl group, an indazolyl group, an imidazolyl group, a benzimidazolyl group, a carbazolyl group, a carbolinyl group, a purinyl group, a furyl group, a thienyl group, an isoxazolyl group, an isothiazolyl group, an oxazolyl group, a thiazolyl group, a benzoxazolyl group, a benzothiazolyl group, an indolidinyl group, a benzoquinolinyl group, a quinolidinyl group, a triazolyl group, a benzotriazolyl group, an naphthylidinyl group and the like. These heteroaryl groups may have a substituent. As the substituent, those mentioned as a substituent held by the groups represented by R¹, R² and R³ in formula (I) can be applied, which also have a similar preferable range.

The group represented by Ar¹, Ar² or Ar³ is preferably a substituted or unsubstituted phenyl group, naphthyl group, anthryl group, phenanthryl group, pyrenyl group, fluorenyl group, pyridyl group, pyrazinyl group, quinolyl group, quinoxalinyl group, acridinyl group, phenanthrolinyl group or benzoquinolinyl group, and more preferably a substituted or unsubstituted phenyl group, naphthyl group, anthryl group, phenanthryl group, pyrenyl group, pyridyl group, pyrazinyl group, quinolyl group, phenanthrolinyl group or benzoquinolinyl group.

A more preferable group of phosphine oxide compounds in the invention is a group of compounds represented by the following formula (III).

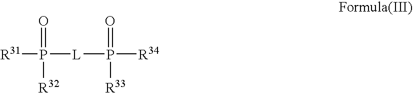

In formula, R³¹ to R³⁴ each independently represents an aryl group or a heterocyclic group. L represents a divalent linking group.

Next, formula (III) is described in detail.

In formula (III), the aryl group or heterocyclic group represented by R³¹ to R³⁴ is the same as the aryl group or heterocyclic group described for R¹ to R³ in formula (I) and also has a similar preferable range. L represents a divalent linking group. The divalent linking group is a linking group preferably comprising a carbon atom, a nitrogen atom, an oxygen atom, a sulfur atom, a silicon atom or a halogen atom, and more preferably comprising a carbon atom, a nitrogen atom or a silicon atom, although it is not particularly limited.

The divalent linking group represented by L is preferably p-phenylene, m-phenylene, o-phenylene, biphenyl-di-yl, naphthalene-di-yl, fluorene-di-yl, dibenzofuran-di-yl, pyridine-di-yl or pyrazine-di-yl, and more preferably biphenyl-di-yl, fluorene-di-yl, pyridine-di-yl or pyrazine-di-yl.

Specific examples of the phosphine oxide compound used in the present invention are shown below, but compounds in the invention are not limited thereto.

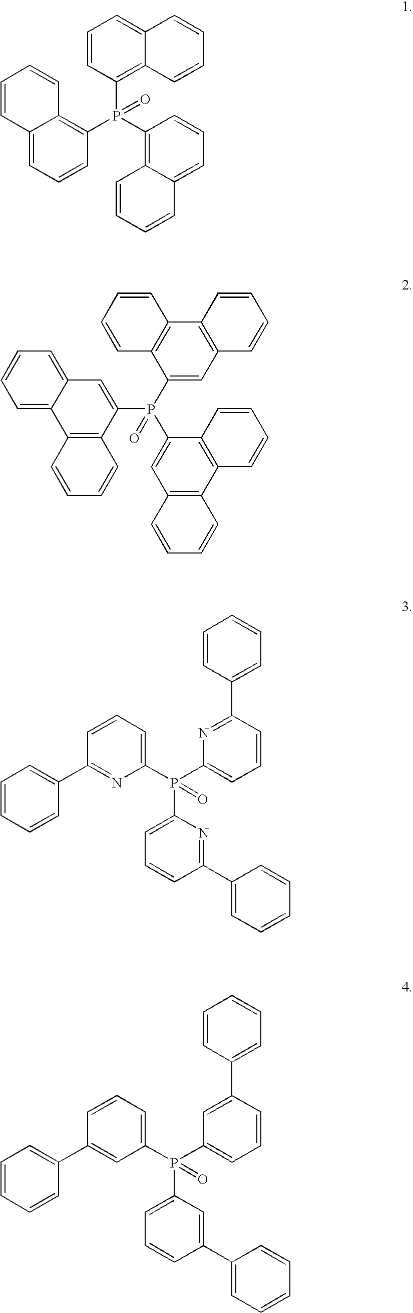

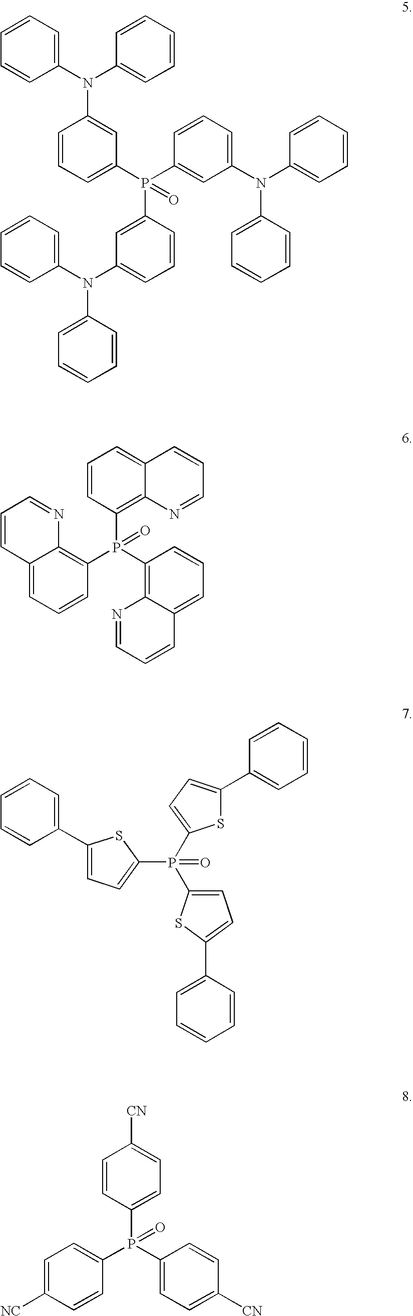

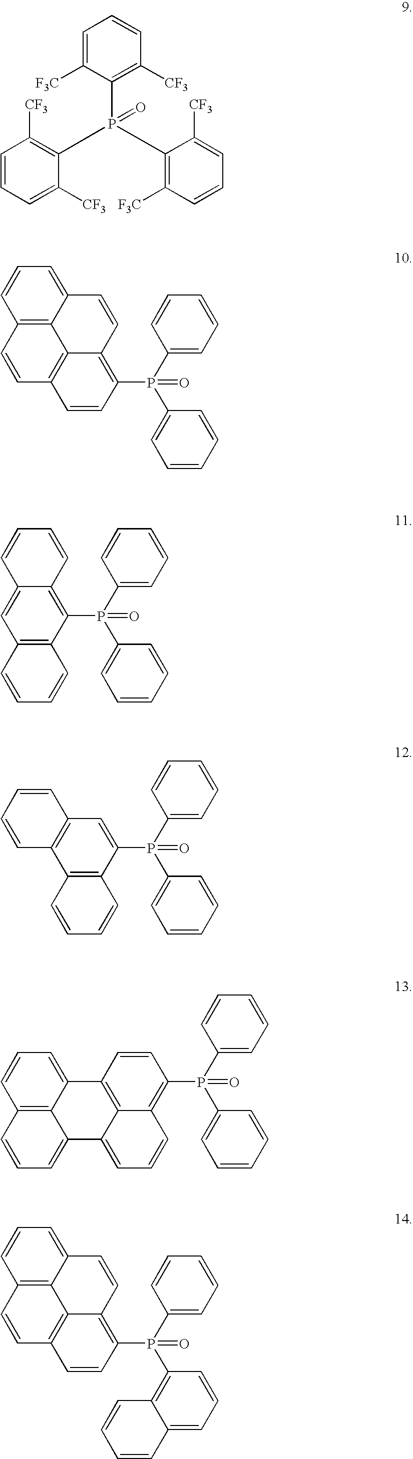

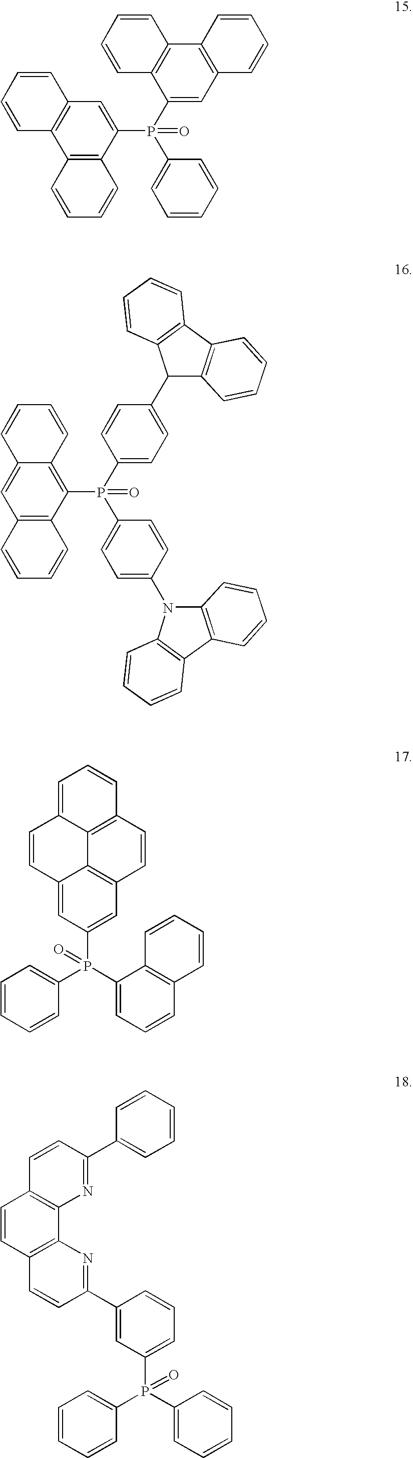

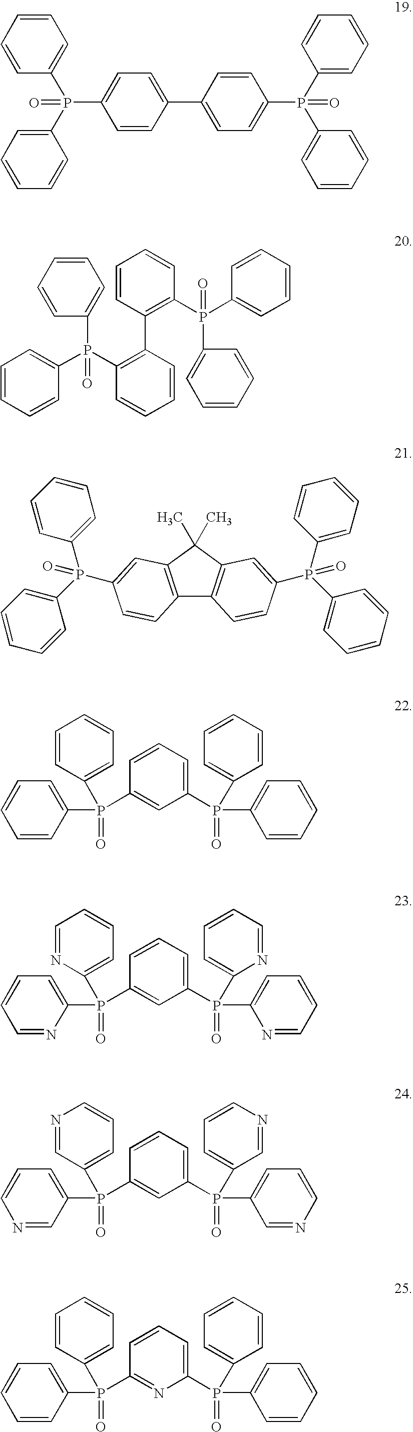

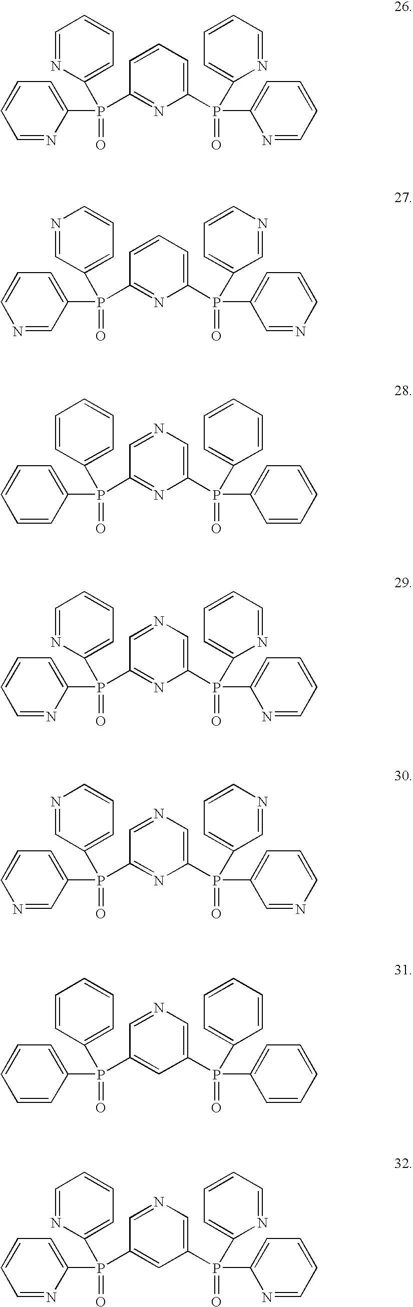

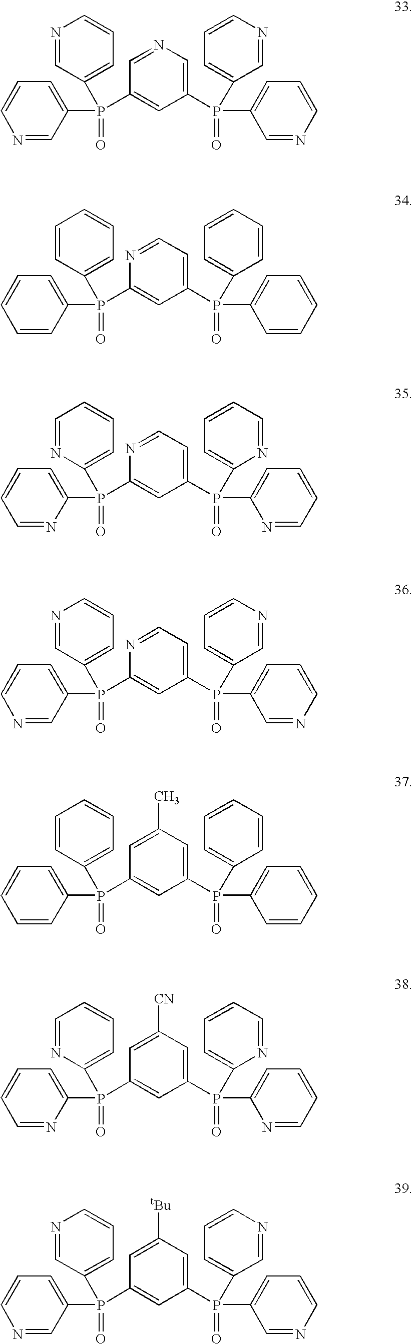

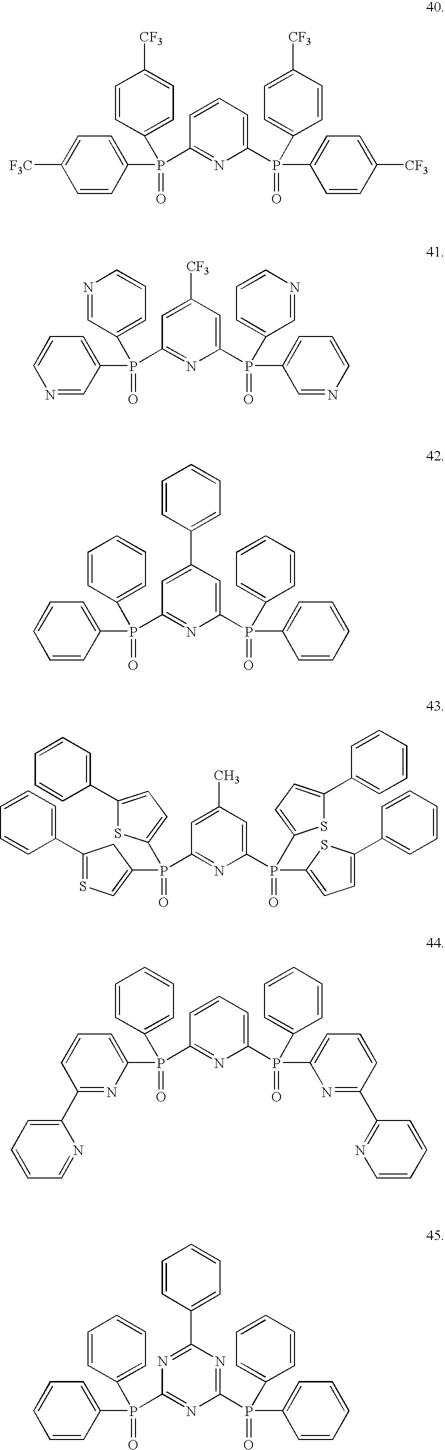

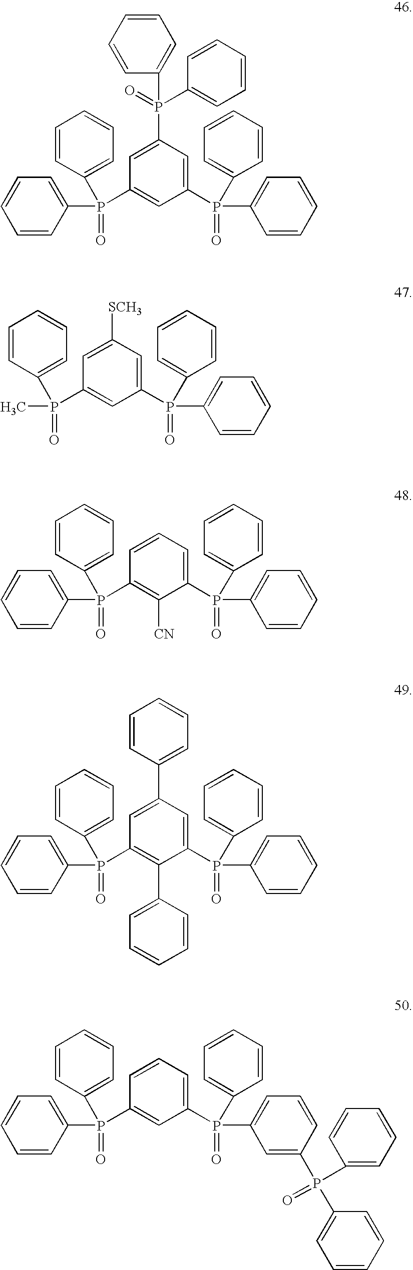

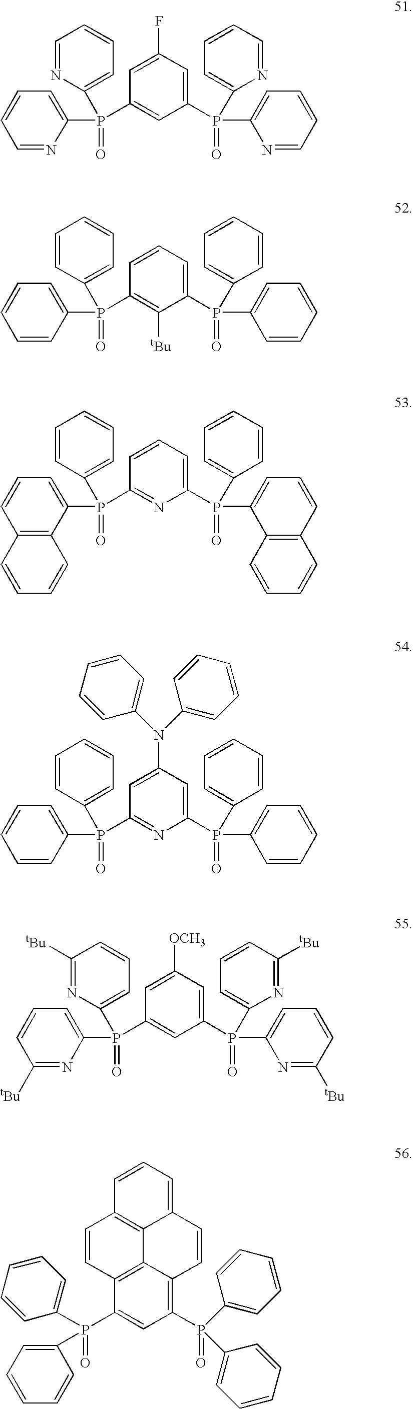

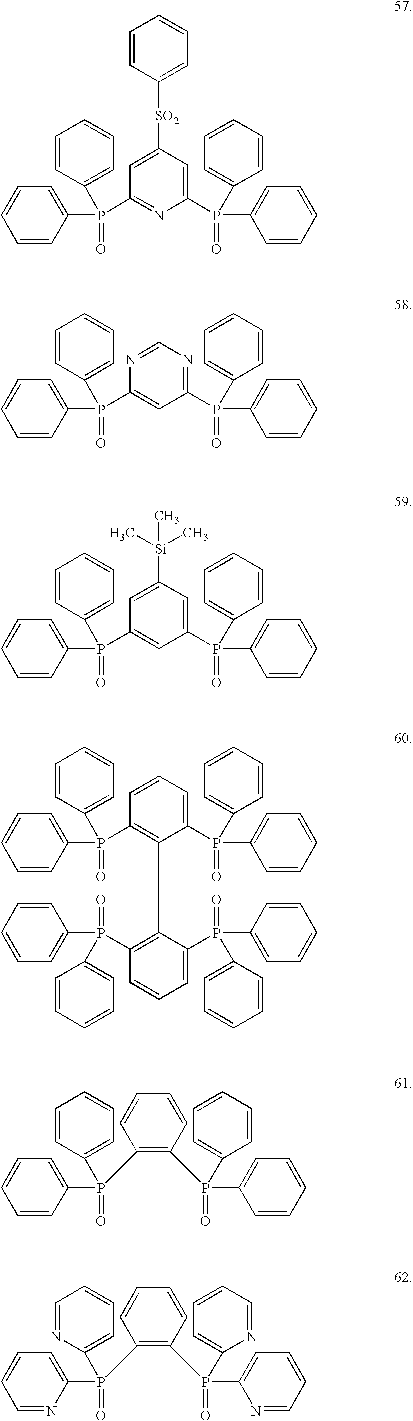

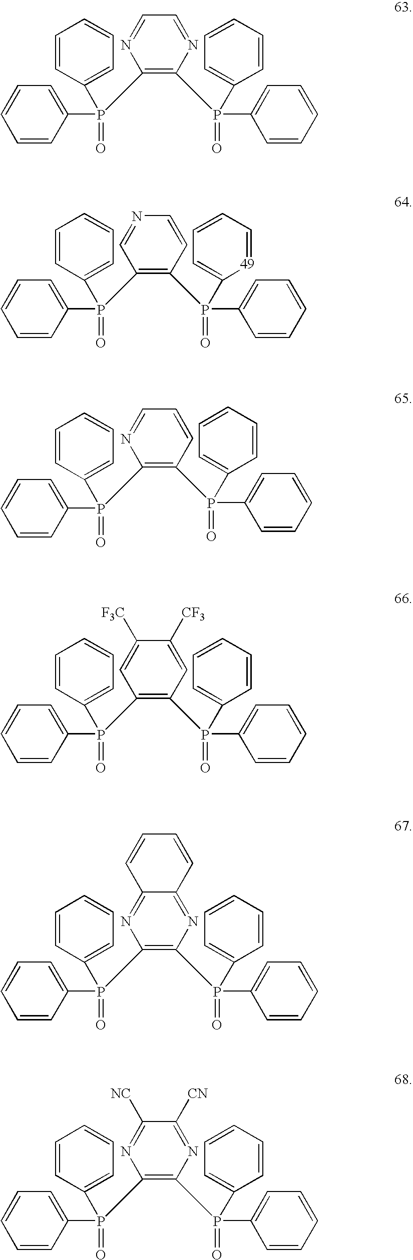

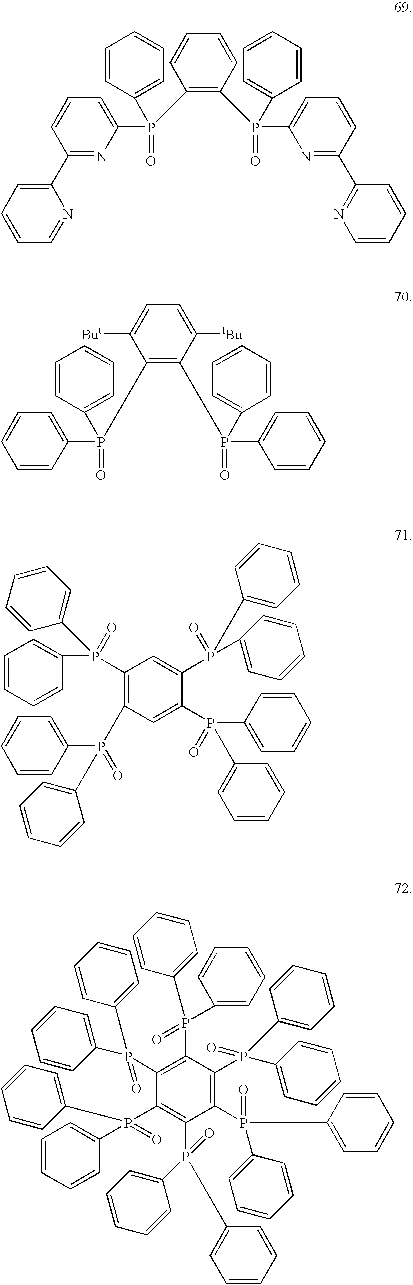

In addition to the above, specific examples of phosphine oxide compounds for use in the invention include, for example, compounds exemplified in JP-A No. 2002-63989, paragraphs from [Kagaku 5] to [Kagaku 7].

In the present invention, the light-emitting layer comprises a host material and a light-emitting material, and at least one of the light-emitting layer and other organic layers comprises a phosphine oxide compound.

Preferably, the phosphine oxide compound contained in the light-emitting layer according to the invention has an ionization potential (Ip value) larger than an Ip value of at least one of the host material or the light-emitting material. More preferably, the phosphine oxide compound contained in the light-emitting layer has an ionization potential (Ip value) larger than each Ip value of the host material and the light-emitting material.

When an ionization potential of a phosphine oxide compound is represented by Ip1, and that of a host material or a light-emitting material is represented by Ip2, ΔIp value represented by the following equation is preferably from 0.1 eV to 2.5 eV.

ΔIp=Ip1−Ip2

More preferably, ΔIp value is from 0.3 eV to 2.5 eV, and even more preferably from 0.5 eV to 2.5 eV.

A content of the phosphine oxide compound in the light-emitting layer is preferably from 5% by weight to 50% by weight based on the total solid content of the light-emitting layer, and more preferably from 15% by weight to 30% by weight. In a range within the preferred content of the phosphine oxide compound, extremely large effects are obtained with respect to drive voltage, external quantum efficiency and drive durability than that in a range outside the preferred range.

Another preferable layer comprising a phosphine oxide compound in the present invention is an organic layer between a cathode and the light-emitting layer, and a hole-blocking layer is disposed between the organic layer and the light-emitting layer.

### <Application Method>

As a method for forming a layer containing a phosphine oxide compound in the invention, although not particularly limited, such a method is used as a resistance heating deposition method, an electron beam method, a sputtering method, a molecular stacking method, a wet coating method (such as a spray coating method, a dip coating method, an impregnating method, a roll coating method, a gravure coating method, a reverse coating method, a roll brush method, an air knife coating method, a curtain coating method, a spin coating method, a flow coating method, a bar coating method, a microgravure coating method, an air doctor coating method, a blade coating method, a squeeze coating method, a transfer roll coating method, a kiss coating method, a cast coating method, an extrusion coating method, a wire bar coating method, a screen coating method or the like), an ink-jet method, a printing method, a transfer method or the like.

### <Thickness of Layer>

A thickness of the light-emitting layer containing a phosphine oxide compound in the present invention is not particularly limited, but generally preferably from 1 nm to 500 nm, more preferably from 5 nm to 200 nm, and particularly preferably from 10 nm to 100 nm.

A thickness of an organic layer containing a phosphine oxide compound disposed between a hole-blocking layer adjacent to a cathode side of the light-emitting layer and the cathode in the present invention is not particularly limited, but generally preferably from 0.1 nm to 200 nm, more preferably from 0.2 nm to 100 nm, and particularly preferably from 0.5 nm to 50 nm.

The thickness above is preferable with respect to fulfill all of drive voltage, light-emission efficiency and drive durability.

### 2. Organic Electroluminescence Element

Hereinafter, components which constitute the electroluminescence element of the invention are described in detail.

### <Substrate>

The substrate to be applied in the invention is preferably one which does not scatter or attenuate light emitted from the organic compound layer. Specific examples of materials for the substrate include zirconia-stabilized yttrium (YSZ); inorganic materials such as glass; polyesters such as polyethylene terephthalate, polybutylene phthalate, and polyethylene naphthalate; and organic materials such as polystyrene, polycarbonate, polyethersulfone, polyarylate, polyimide, polycycloolefin, norbornene resin, polychlorotrifluoroethylene, and the like.

For instance, when glass is used as the substrate, non-alkali glass is preferably used with respect to the quality of material in order to decrease ions eluted from the glass. In the case of employing soda-lime glass, it is preferred to use glass on which a barrier coat of silica or the like has been applied. In the case of employing an organic material, it is preferred to use a material excellent in heat resistance, dimension stability, solvent resistance, electric insulation, and workability.

There is no particular limitation as to the shape, the structure, the size or the like of the substrate, and it may be suitably selected according to the application, purposes and the like of the light-emitting element. In general, a plate-like substrate is preferred as the shape of the substrate. A structure of the substrate may be a monolayer structure or a laminated structure. Furthermore, the substrate may be formed from a single member or two or more members.

Although the substrate may be transparent and colorless, or transparent and colored, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

### <Anode>

The anode generally has a function as an electrode for supplying holes to the organic compound layer, and there is no particular limitation as to the shape, the structure, the size or the like. It may be suitably selected from among well-known electrode materials according to the application and purpose of the light-emitting element. As mentioned above, the anode is usually provided as a transparent anode.

Materials for the anode preferably include, for example, metals, alloys, metal oxides, electroconductive compounds, and mixtures thereof. Specific examples of the anode materials include electroconductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electroconductive metal oxides; inorganic electroconductive materials such as copper iodide and copper sulfide; organic electroconductive materials such as polyaniline, polythiophene, and polypyrrole; and laminates of these inorganic or organic electroconductive materials with ITO. Among these, the electroconductive metal oxides are preferred, and particularly, ITO is preferable in view of productivity, high electroconductivity, transparency and the like.

The anode may be formed on the substrate in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the anode. For instance, when ITO is selected as a material for the anode, the anode may be formed in accordance with a DC or high-frequency sputtering method, a vacuum deposition method, an ion plating method or the like.

In the organic electroluminescence element of the present invention, a position at which the anode is to be formed is not particularly limited, and it may be suitably selected according to the application and purpose of the light-emitting element. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, a lift-off method or a printing method may be applied.

A thickness of the anode may be suitably selected according to the material constituting the anode and is therefore not definitely decided, but it is usually in a range of from 10 nm to 50 μm, and preferably from 50 nm to 20 μm.

A value of resistance of the anode is preferably 10³Ω/□ or less, and more preferably 10²Ω/□ or less. In the case where the anode is transparent, it may be either transparent and colorless, or transparent and colored. For extracting luminescence from the transparent anode side, it is preferred that a light transmittance of the anode is 60% or higher, and more preferably 70% or higher.

Concerning transparent anodes, there is a detailed description in “TOUMEI DENNKYOKU-MAKU NO SHINTENKAI (Novel Developments in Transparent Electrode Films)” edited by Yutaka Sawada, published by C.M.C. in 1999, the contents of which are incorporated by reference herein. In the case where a plastic substrate having a low heat resistance is applied, it is preferred that ITO or IZO is used to obtain a transparent anode prepared by forming the film at a low temperature of 150° C. or lower.

### <Cathode>

The cathode generally has a function as an electrode for injecting electrons to the organic compound layer, and there is no particular limitation as to the shape, the structure, the size or the like. It may be suitably selected from among well-known electrode materials according to the application and purpose of the light-emitting element.

Materials constituting the cathode include, for example, metals, alloys, metal oxides, electroconductive compounds, and mixtures thereof. Specific examples thereof include alkaline metals (e.g., Li, Na, K, Cs or the like), alkaline earth metals (e.g., Mg, Ca or the like), gold, silver, lead, aluminum, sodium-potassium alloys, lithium-aluminum alloys, magnesium-silver alloys, rare earth metals such as indium, and ytterbium, and the like. They may be used alone, but it is preferred that two or more of them are used in combination from the viewpoint of satisfying both stability and electron injectability.

Among these, as the materials for constituting the cathode, alkaline metals or alkaline earth metals are preferred in view of electron injectability, and materials containing aluminum as a major component are preferred in view of excellent preservation stability.

The term “material containing aluminum as a major component” refers to a material constituted by aluminum alone; alloys comprising aluminum and 0.01% by weight to 10% by weight of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, the contents of which are incorporated by reference herein.

A method for forming the cathode is not particularly limited, and it may be formed in accordance with a well-known method. For instance, the cathode may be formed in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the cathode. For example, when a metal (or metals) is (are) selected as a material (or materials) for the cathode, one or two Or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted between the cathode and the organic compound layer with a thickness of from 0.1 nm to 5 nm. The dielectric layer may be considered to be a kind of electron injection layer. The dielectric material layer may be formed in accordance with, for example, a vacuum deposition method, a sputtering method, an ionplating method or the like.

A thickness of the cathode may be suitably selected according to materials for constituting the cathode and is therefore not definitely decided, but it is usually in a range of from 10 nm to 5 μm, and preferably from 50 nm to 1 μm.

Moreover, the cathode may be transparent or opaque. The transparent cathode may be formed by preparing a material for the cathode with a small thickness of from 1 nm to 10 nm, and further laminating a transparent electroconductive material such as ITO or IZO thereon.

### <Organic Compound Layer>

The organic compound layer according to the present invention is to be described.

The organic electroluminescence element of the present invention has at least one organic compound layer including a light-emitting layer. An organic compound layer apart from the light-emitting layer comprises a hole transport layer, an electron transport layer, a charge-blocking layer, a hole injection layer, an electron injection layer and the like as described above.

### —Formation of Organic Compound Layer—

In the organic electroluminescence element of the present invention, the respective layers constituting the organic compound layer can be suitably formed in accordance with any of a dry film-forming method such as a vapor deposition method or a sputtering method; a wet film-forming method; a transfer method; a printing method; an ink-jet method; or the like.

### —Organic Light-Emitting Layer—

The organic light-emitting layer is a layer having functions of receiving holes from the anode, the hole injection layer, or the hole transport layer, and receiving electrons from the cathode, the electron injection layer, or the electron transport layer, and providing a field for recombination of the holes with the electrons to emit light, when an electric field is applied to the layer.

The light-emitting layer according to the present invention contains a light-emitting material and a host material. The light-emitting material may be a fluorescent light-emitting material or a phosphorescent light-emitting material, and the dopant may be one or a plurality of compounds. Preferably, the host material is a charge-transporting material. The host material may be one or a plurality of compounds, and, for example, a mixture of a hole-transporting host material and an electron-transporting host material is preferable. Further, a material which does not emit light nor transport any charge may be contained in the light-emitting layer.

The light-emitting layer may be a single layer or a plurality of layers, wherein the layers may emit light with respectively different colors.

The light-emitting material which can be used in the present invention may be a fluorescent light-emitting material or a phosphorescent light-emitting material, and may be a low molecular compound or a high molecular compound.

Examples of fluorescent light-emitting materials usable in the present invention include, for example, a benzofuran derivative, a benzothiophene derivative, a pyran derivative, a benzoxazole derivative, a benzimidazole derivative, a benzothiazole derivative, a styrylbenzene derivative, a polyphenyl derivative, a diphenylbutadiene derivative, a tetraphenylbutadiene derivative, a naphthalimide derivative, a coumarin derivative, condensed aromatic compounds, a perylene derivative, an oxadiazole derivative, an oxazine derivative, an aldazine derivative, a pyrazine derivative, a cyclopentadiene derivative, a bis-styrylanthracene derivative, a quinacridone derivative, a pyrrolopyridine derivative, a thiadiazolopyridine derivative, a cyclopentadiene derivative, a styrylamine derivative, a diketopyrrolopyrrole derivative, aromatic dimethylidene compounds, a variety of metal complexes represented by metal complexes of an 8-quinolynol derivative or metal complexes of a pyrromethene derivative, polymer compounds such as polythiophene, polyphenylene and polyphenylenevinylene, compounds such as an organosilane derivative and the like.

Examples of the phosphorescent light-emitting material which can be used in the invention include complexes containing a transition metal atom or a lanthanoid atom.

For instance, although the transition metal atom is not particularly limited, it is preferably ruthenium, rhodium, palladium, tungsten, rhenium, osmium, iridium, or platinum; and more preferably rhenium, iridium, or platinum.

Examples of the lanthanoid atom include lanthanum, cerium, praseodymium, neodymium, samarium, europium, gadolinium, terbium, dysprosium, holmium, erbium, thulium, ytterbium, and lutetium, and among these lanthanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU—(Organometallic Chemistry —Fundamental and Application—)” authored by Akio Yamamoto, published by Shokabo Publishing Co., Ltd. in 1982.

Specific examples of the ligands include preferably halogen ligands (preferably chlorine ligands), aromatic ligands (e.g., cyclopentadienyl anions, benzene anions, or naphthyl anions and the like), nitrogen-containing heterocyclic ligands (e.g., phenylpyridine, benzoquinoline, isoquinoline, quinolinol, bipyridyl, or phenanthroline and the like), diketone ligands (e.g., acetylacetone and the like), carboxylic acid ligands (e.g., acetic acid ligands, picolinates and the like), alcohol ligands (e.g., phenolate ligands and the like), carbon monoxide ligands, isonitryl ligands, and cyano ligand, and more preferably nitrogen-containing heterocyclic ligands. The above-described complexes may be either a complex containing one transition metal atom in the compound, or a so-called polynuclear complex containing two or more transition metal atoms wherein different metal atoms may be contained at the same time.

The phosphorescent light-emitting material is preferably contained in an amount of from 0.1% by weight to 40% by weight in the light-emitting layer, and more preferably in an amount of from 0.5% by weight to 30% by weight.

Examples of the hole transporting host contained in the light-emitting layer of the present invention includes compounds having a pyrrole skeleton, compounds having an indole skeleton, compounds having a carbazole skeleton, compounds having a diarylamine skeleton, compounds having a pyridine skeleton, compounds having a pyrazine skeleton, compounds having a triazine skeleton, compounds having an arylsilane skeleton, and materials exemplified in the explanation of the hole injection material, hole-transporting material, electron injection material, and electron-transporting material described below.

Although a thickness of the light-emitting layer is not particularly limited, 1 nm to 500 nm is usually preferred, 5 nm to 200 nm is more preferable, and 10 nm to 100 nm is even more preferable.

### —Hole Injection Layer and Hole Transport Layer—

The hole injection layer and hole transport layer correspond to layers functioning to receive holes from an anode or from an anode side and to transport the holes to a cathode side. Materials which can be used in the hole injection layer or the hole transport layer according to the invention are not particularly limited, but either of a low molecular compound or a high molecular compound may be used.

As a material for the hole injection layer and the hole transport layer, it is preferred that the layers contain specifically pyrrole derivatives, carbazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives, carbon, metal complexes having phenylazole or phenylazine as a ligand, or the like.

An electron-accepting dopant may be introduced into the hole injection layer or the hole transport layer in the organic electroluminescence element of the present invention. As the electron-accepting dopant to be introduced into the hole injection layer or the hole transport layer, either of an inorganic compound or an organic compound may be used as long as the compound has an electron-accepting property and a property of oxidizing an organic compound.

Specifically, the inorganic compound includes metal halides, such as ferric chloride, aluminum chloride, gallium chloride, indium chloride, antimony pentachloride and the like, and metal oxides, such as vanadium pentaoxide, molybdenum trioxide and the like.

In the case of using the organic compounds, compounds having a substituent such as a nitro group, a halogen, a cyano group, a trifluoromethyl group or the like; quinone compounds; acid anhydride compounds; fullerenes; and the like may be preferably applied.

Specific examples thereof other than those above include compounds described in JP-A Nos. 6-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637, 2005-209643 and the like.

These electron-accepting dopants may be used alone or in a combination of two or more of them.

Although an applied amount of these electron-accepting dopants depends on the type of material, 0.01% by weight to 50% by weight is preferred with respect to a hole injection layer material or a hole transport layer material, 0.05% by weight to 20% by weight is more preferable, and 0.1% by weight to 10% by weight is particularly preferred.

A thickness of the hole injection layer and a thickness of the hole transport layer are preferably 500 nm or less, respectively in view of decreasing drive voltage.

The thickness of the hole transport layer is preferably from 1 nm to 500 nm, more preferably from 5 nm to 300 nm, and even more preferably from 10 nm to 200 nm. The thickness of the hole injection layer is preferably from 0.1 nm to 500 nm, more preferably from 0.5 nm to 300 nm, and even more preferably from 1 nm to 200 nm.

The hole injection layer and the hole transport layer may be composed of a monolayer structure comprising one or two or more of the above-mentioned materials, or a multilayer structure composed of plural layers of a homogeneous composition or a heterogeneous composition.

### —Electron Injection Layer and Electron Transport Layer—

The electron injection layer and the electron transport layer are a layers having a function of receiving electrons from the cathode or cathode side and transporting the electrons to the anode side. A material used in the electron injection layer or the electron transport layer of the present invention is not particularly limited, and may be a low molecular compound or a high molecular compound.

Specific examples thereof include a pyridine derivative, a quinoline derivative, a pyrimidine derivative, a pyrazine derivative, a phthalazine derivative, a phenanthroline derivative, a triazine derivative, a triazole derivative, an oxazole derivative, an oxadiazole derivative, an imidazole derivative, a fluorenone derivative, an anthraquinodimethane derivative, an anthrone derivative, a diphenylquinone derivative, a thiopyran dioxide derivative, a carbodiimide derivative, a fluorenylidenemethane derivative, a distyrylpyrazine derivative, a tetracarboxylic anhydride of an aromatic compound such as naphthalene or perylene, a phthalocyanine derivative, various metal complexes as typically represented by a metal complex of a 8-quinolinol derivative or metal phthalocyanine, a metal complex containing benzoxazole or benzothiazole as a ligand, or an organosilane derivative typically represented by silole, and the like.

In the electron injection layer or the electron transport layer of the organic EL element of the invention, an electron donating dopant may be contained. As a material applied for the electron-donating dopant contained in the electron injection layer or the electron transport layer, any material may be used as long as it has an electron-donating property and a property of reducing an organic compound, and alkaline metals such as Li, alkaline earth metals such as Mg, transition metals including rare-earth metals and organic reducing compounds are preferably used. Particularly, metals having a work function of 4.2 eV or less are preferably applied, and specific examples thereof include Li, Na, K, Be, Mg, Ca, Sr, Ba, Y, Cs, La, Sm, Gd, and Yb. Also examples of the organic reducing compound include a nitrogen-containing compound, a sulfur-containing compound and a phosphorus-containing compound.

In addition, materials described in JP-A Nos. 6-212153, 2000-196140, 2003-68468, 2003-229278 and 2004-342614 may be used.

These electron-donating dopants may be used alone or in a combination of two or more of them. An applied amount of the electron-donating dopants differs dependent on the types of the materials, but it is preferably from 0.1% by weight to 30% by weight with respect to an electron injection layer material or an electron transport layer material, more preferably from 0.1% by weight to 20% by weight, and particularly preferably from 0.1% by weight to 10% by weight.

A thickness of the electron injection layer and a thickness of the electron transport layer are preferably 500 nm or less, respectively in view of decreasing drive voltage.

The thickness of the electron transport layer is preferably from 1 nm to 500 nm, more preferably from 5 nm to 200 nm, and even more preferably from 10 nm to 100 nm. The thickness of the electron injection layer is preferably from 0.1 nm to 200 nm, more preferably from 0.2 nm to 100 nm, and even more preferably from 0.5 nm to 50 nm.

The electron injection layer and the electron transport layer may be composed of a monolayer structure comprising one or two or more of the above-mentioned materials, or a multilayer structure composed of plural layers of a homogeneous composition or a heterogeneous composition.

### —Hole-Blocking Layer—

A hole-blocking layer is a layer having a function to prevent the holes transported from the anode side to the light-emitting layer from passing through to the cathode side. According to the present invention, a hole-blocking layer may be provided as an organic compound layer adjacent to the light-emitting layer on the cathode side.

Examples of the compound constituting the hole-blocking layer include an aluminum complex such as BAlq, a triazole derivative, a phenanthroline derivative such as BCP, and the like.

A thickness of the hole-blocking layer is preferably from 1 nm to 500 nm, more preferably from 5 nm to 200 nm, and even more preferably from 10 nm to 100 nm.

The hole-blocking layer may have either a monolayer structure comprising one or two or more of the above-mentioned materials, or a multilayer structure composed of plural layers of a homogeneous composition or a heterogeneous composition.

### —Electron-Blocking Layer—

An electron-blocking layer is a layer having a function to prevent the electrons transported from the cathode side to the light-emitting layer from passing through to the anode side. According to the present invention, an electron-blocking layer may be provided as an organic compound layer adjacent to the light-emitting layer on the anode side.

Specific examples of the compound constituting the electron-blocking layer include compounds explained above as a hole-transporting material.

A thickness of the electron-blocking layer is preferably from 1 nm to 500 nm, more preferably from 5 nm to 200 nm, and even more preferably from 10 nm to 100 nm.

The electron-blocking layer may have either a monolayer structure comprising one or two or more of the above-mentioned materials, or a multilayer structure composed of plural layers of a homogeneous composition or a heterogeneous composition.

### <Protective Layer>

According to the present invention, the whole organic EL element may be protected by a protective layer.

A material contained in the protective layer may be one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AIF₃, CaF₂ and the like; polyethylene; polypropylene; polymethylmethacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

### <Sealing>

The whole organic electroluminescence element of the present invention may be sealed with a sealing cap.

Furthermore, a moisture absorbent or an inert liquid may be used to seal a space defined between the sealing cap and the light-emitting element. Although the moisture absorbent is not particularly limited, specific examples thereof include barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorine-based solvents such as perfluoroalkanes, perfluoroamines, perfluoroethers and the like; chlorine-based solvents; silicone oils; and the like.

### <Driving>

In the organic electroluminescence element of the present invention, when a DC (AC components may be contained as needed) voltage (usually 2 volts to 15 volts) or DC is applied across the anode and the cathode, luminescence can be obtained.

For the driving method of the organic electroluminescence element of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

In the light-emitting element of the present invention, the light-extraction efficiency can be improved by various known methods. It is possible to elevate the light-extraction efficiency and to improve the external quantum efficiency, for example, by modifying the surface shape of the substrate (for example by forming fine irregularity pattern), by controlling the refractive index of the substrate, the ITO layer and/or the organic compound layer, or by controlling the thickness of the substrate, the ITO layer and/or the organic compound layer.

The organic electroluminescence element of the present invention may have a so-called top-emission configuration in which the light emission is extracted from the cathode side.

### APPLICATION OF THE PRESENT INVENTION

The organic electroluminescence element of the present invention can be appropriately used for indicating elements, displays, backlights, electronic photographs, illumination light sources, recording light sources, exposure light sources, reading light sources, signages, advertising displays, interior accessories, optical communications and the like.

All publications, patent applications, and technical standards mentioned in this specification are herein incorporated by reference to the same extent as if each individual publication, patent application, or technical standard was specifically and individually indicated to be incorporated by reference.

### EXAMPLES

The present invention will be further clarified by way of examples, but the present invention is not limited to such examples.

### Example 1

### Preparation of Organic EL Element

<Preparation of Comparative Organic EL Element No. A1>

### 1) Formation of Anode

A product (by Tokyo Sanyo Vacuum Industries Co., Ltd.) manufactured by depositing indium tin oxide (hereinafter, referred to as “ITO”) in a thickness of 100 nm to form a film on a 25 mm×25 mm×0.7 mm glass substrate was used as a transparent substrate. The transparent substrate was subjected to etching and washing.

### 2) Hole Injection/Transport Layer

On the ITO glass substrate, cupper phthalocyanine (hereinafter, referred to as “CuPc”) was deposited to give a thickness of 10 nm, and thereafter, N,N′-di-naphthyl-N,N′-diphenyl-[1,1′-biphenyl]-4,4′-diamine (hereinafter, referred to as “α-NPD”) was deposited to give a film thickness of 50 nm.

### 3) Light-Emitting Layer

Next, on the hole injection/transport layer, phosphine oxide compound A as a host material and iridium (III) bis[4,6-(di-fluorophenyl)pyridinato-N, C2′] picolinate (hereinafter, referred to as “FIrpic”) as a light-emitting material were co-deposited, wherein an amount of Flrpic was 5% by weight with respect to that of phosphine oxide compound A. The thickness was 40 nm.

### 4) Electron Transport Layer

Thereafter, aluminum (III) bis(2-methyl-g-quinolinato)-4-phenylphenolate (hereinafter, referred to as “BAlq”) was deposited to give a thickness of 40 nm.

### 5) Electron Injection Layer

In addition, LiF was deposited to give a thickness of 1 nm.

### 6) Formation of Cathode

On this layer, a patterned mask (a mask for giving a light-emission area of 2 mm×2 mm) was arranged and aluminum was deposited in a thickness of about 100 nm to prepare an element. The prepared element was sealed in a dry glove box.

The above-described deposition was performed under such conditions as a vacuum of from 10⁻³ Pa to 10⁻⁴ Pa and a substrate temperature of room temperature.

### <Preparation of Organic EL Element No. 1 of the Invention>

Organic EL element No. 1 of the invention was prepared in a manner similar to that in preparing the comparative organic EL element No. A1, except for using the following light-emitting layer in preparing the comparative organic EL element No. A1.

Light-emitting layer: FIrpic, 1,3-bis(N-carbazolyl-9-yl)benzene (hereinafter referred to as “mCP”) and phosphine oxide compound A were co-deposited, wherein mCP and phosphine oxide compound A were contained at 95% by weight and 5% by weight, respectively, and an amount of FIrpic was 5% by weight with respect to a total amount of mCP and phosphine oxide compound A. The thickness was 40 nm.

### <Preparation of Organic EL Element No. 2 of the Invention>

Organic EL element No. 2 of the invention was prepared in a manner similar to that in preparing the comparative organic EL element No. A1, except for using the following light-emitting layer in preparing the comparative organic EL element No. A1.

Light-emitting layer: FIrpic, mCP and phosphine oxide compound A were co-deposited, wherein mCP and phosphine oxide compound A were contained at 85% by weight and 15% by weight, respectively, and an amount of Flrpic was 5% by weight with respect to a total amount of mCP and phosphine oxide compound A. The thickness was 40 nm.

### <Preparation of Organic EL Element No. 3 of the Invention>

Organic EL element No. 3 of the invention was prepared in a manner similar to that in preparing the comparative organic EL element No. A1, except for using the following light-emitting layer in preparing the comparative organic EL element No. A1.

Light-emitting layer: Flrpic, mCP and phosphine oxide compound A were co-deposited, wherein mCP and phosphine oxide compound A were contained at 70% by weight and 30% by weight, respectively, and an amount of Flrpic was 5% by weight with respect to a total amount of mCP and phosphine oxide compound A. The thickness was 40 nm.

### <Preparation of Organic EL Element No. 4 of the Invention>

Organic EL element No. 4 of the invention was prepared in a manner similar to that in preparing the comparative organic EL element No. A1, except for using the following light-emitting layer in preparing the comparative organic EL element No. A1.

Light-emitting layer: Flrpic, mCP and phosphine oxide compound A were co-deposited, wherein mCP and phosphine oxide compound A were contained at 50% by weight and 50% by weight, respectively, and an amount of Flrpic was 5% by weight with respect to a total amount of mCP and phosphine oxide compound A. The thickness was 40 nm.

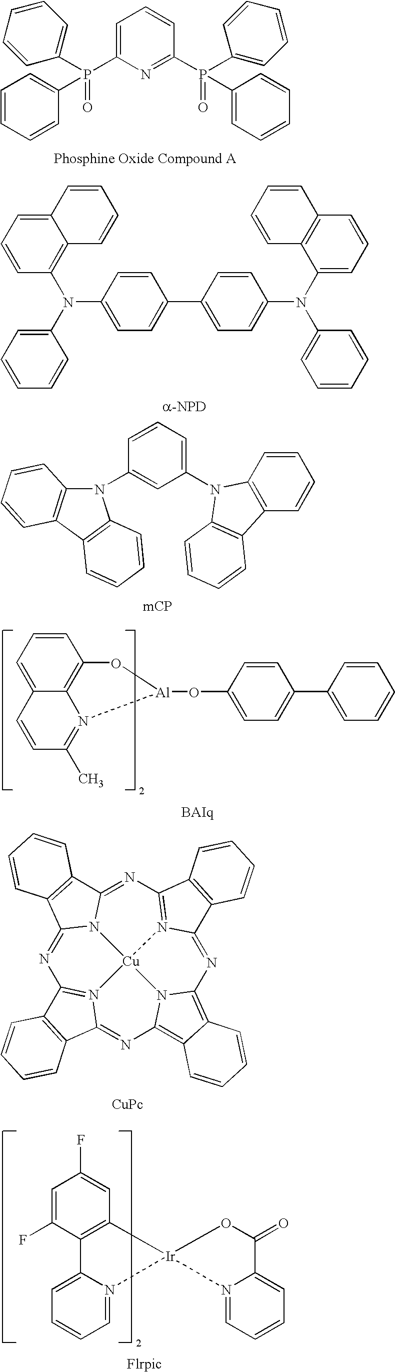

### (Evaluation of Performance of Organic El Element)

### 1) External Quantum Efficiency

Direct current voltage was applied to respective elements using a Source Measure Unit 2400 manufactured by Toyo Technica Corporation to enable them to emit light. The brightness thereof was measured with a brightness meter BM-8 manufactured by TOPCON CORPORATION. Emission spectrum and emission wavelengths were measured with a spectrum analyzer PMA-11 manufactured by Hamamatsu Photonics K. K. On the basis of the obtained numerical values, the external quantum efficiency at the brightness of 1000 cd/m² was calculated by a brightness conversion method.

### 2) Drive Voltage

Direct current voltage was applied to respective elements using a Source Measure Unit 2400 manufactured by Toyo Technica Corporation to enable them to emit light. The voltage when the current applied to the element reached to 10 mA/cm² was measured to give the drive voltage.

### 3) Drive Durability: Brightness Half Decay Time

Each of elements was applied with direct current voltage to give brightness of 1000 cd/m². Then, the element was continuously driven to measure the time until the brightness decreased to 500 cd/m². The brightness half decay time of each elements is shown as relative value with respect to that of comparative element A1, wherein the brightness half decay time of comparative element A1 was designated as 1. The brightness half decay time is used as a measure of the drive durability.

The obtained results are listed in Table 1 below.

TABLE 1

| | Drive | External Quantum | Brightness Half Decay |
|---|---|---|---|
| Element No. | Voltage (V) | Efficiency (%) | Time (Relative Value) |
| Element A1 for | 10.2 | 7.9 | 1 |
| comparison | | | |
| Element 1 of | 10.4 | 7.9 | 121 |
| the invention | | | |
| Element 2 of | 10.3 | 8.0 | 153 |
| the invention | | | |
| Element 3 of | 10.3 | 8.0 | 147 |
| the invention | | | |
| Element 4 of | 10.2 | 8.1 | 105 |
| the invention | | | |

As is clear from the above results, the element Nos. 1, 2, 3, 4 of the invention showed unexpectedly increased drive durability by 100 times or more compared with the comparative element No. A1, while the external quantum efficiency and drive voltage thereof were kept in similar level. That is, it is clear that the elements of the invention including a phosphine oxide compound in the light-emitting layer at an amount of from 5% by weight to 50% by weight with respect to the total solid content of the light-emitting layer exhibit an unexpectedly excellent effect.

### Example 2

### Preparation of Organic EL Element

<Preparation of Comparative Organic EL Element No. B1>

### 1) Formation of Anode

A 25 mm×25 mm×0.7 mm glass substrate, on which ITO was deposited with a thickness of 100 nm (manufactured by Tokyo Sanyo Vacuum Industries Co., Ltd.) was used as a transparent substrate. The transparent substrate was subjected to etching and washing.

### 2) Hole Injection Layer

On this ITO glass substrate, 4,4′,4″-tris (2-naphthylphenylamino)triphenylamine (hereinafter referred to as “2-TNATA”) and 2,3,5,6-tetrafluoro-7,7,8,8-tetracyanoquinodimethane (hereinafter referred to as “F4-TCNQ”) were co-deposited, wherein an amount of F4-TCNQ was 0.3% by weight with respect to that of 2-TNATA. The thickness was 160 nm.

### 3) Hole Transport Layer

On the hole injection layer, α-NPD was deposited to give a film thickness of 10 nm.

### 4) Light-Emitting Layer

On the hole transport layer, a light-emitting layer containing 4,4′-di-(N-carbazole)-biphenyl (hereinafter, referred to as “CBP”) as a host material and tris (1-phenylisoquinoline) iridium(III) (hereinafter, referred to as “Ir(piq)₃”) as a light-emitting material was co-deposited, wherein the amount of Ir(ppy)₃ was 8% by weight with respect to that of CBP. The thickness was 60 nm.

### 5) Electron Transport Layer

Thereafter, BAlq as an electron-transporting material was deposited to give a thickness of 40 nm.

### 6) Electron Injection Layer

In addition, LiF was deposited to give a thickness of 1 nm.

### 7) Formation of Cathode

On this layer, a patterned mask (a mask for giving a light-emission area of 2 mm×2 mm) was arranged and aluminum was deposited in a thickness of about 100 nm to prepare an element. The prepared element was sealed in a dry glove box.

The above-described deposition was performed under such conditions as a vacuum of from 10⁻³ Pa to 10⁻⁴ Pa and a substrate temperature of room temperature.

### <Preparation of Organic EL Element No. 11 of the Invention>

Organic EL element No. 11 of the invention was prepared in a manner similar to that in preparing the comparative organic EL element No. B1, except for using the following light-emitting layer in preparing the comparative organic EL element No. B1.

Light-emitting layer: Ir(piq)₃, CBP and phosphine oxide compound B were co-deposited, wherein CBP and phosphine oxide compound B were contained at 70% by weight and 30% by weight, respectively, and an amount of Ir(piq)₃ was 8% by weight with respect to a total amount of CBP and phosphine oxide compound B. The thickness was 60 nm.

### <Preparation of Organic EL Element No. 12 of the Invention>

Organic EL element No. 12 of the invention was prepared in a manner similar to that in preparing the comparative organic EL element No. B1, except for using the following light-emitting layer and an electron transport layer, and further using the following hole-blocking layer between the light-emitting layer and the electron transport layer in preparing the comparative organic EL element No. B1.

Light-emitting layer: Ir(piq)₃, CBP and phosphine oxide compound B were co-deposited, wherein CBP and phosphine oxide compound B were contained at 85% by weight and 15% by weight, respectively, and an amount of Ir(piq)₃ was 8% by weight with respect to a total amount of CBP and phosphine oxide compound B. The thickness was 60 nm.

Hole-blocking layer: BAlq was deposited to give a thickness of 30 nm.

Electron transport layer: phosphine oxide compound B was deposited to give a thickness of 10 nm.

### <Preparation of Organic EL Element No. 13 of the Invention>

Organic EL element No. 13 of the invention was prepared in a manner similar to that in preparing the comparative organic EL element No. B1, except for using the following light-emitting layer and electron transport layer, and further using the following hole-blocking layer between the light-emitting layer and the electron transport layer in preparing the comparative organic EL element No. B1.

Light-emitting layer: Ir(piq)₃, CBP and phosphine oxide compound B were co-deposited, wherein CBP and phosphine oxide compound B were contained at 85% by weight and 15% by weight, respectively, and an amount of Ir(piq)₃ was 8% by weight with respect to a total amount of CBP and phosphine oxide compound B. The thickness was 60 nm.

Hole-blocking layer: BAlq was deposited to give a thickness of 30 nm.

Electron transport layer: BAlq and phosphine oxide compound B were co-deposited, wherein BAlq and phosphine oxide compound B was contained at 50% by weight and 50% by weight, respectively. The thickness was 10 nm.

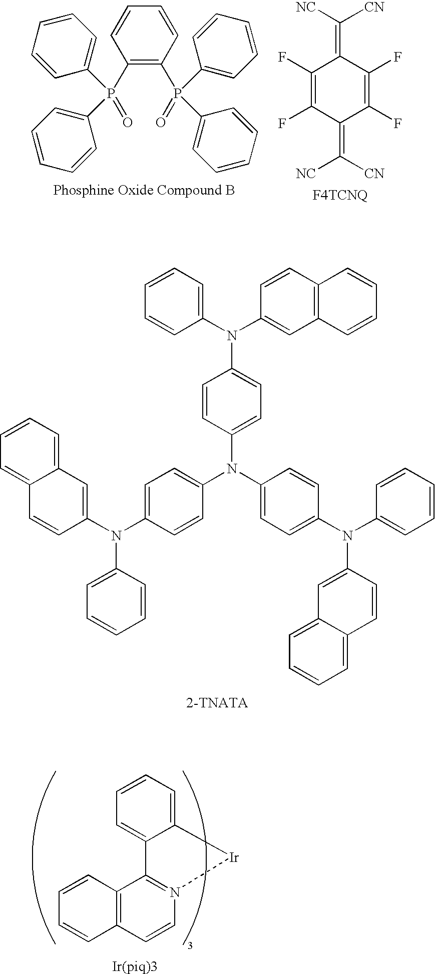

### (Evaluation of Performance of Organic El Element)

Evaluation was conducted with respect to the external quantum efficiency, the drive voltage, and the drive durability in a similar manner as in the evaluation of EXAMPLE 1.

The obtained results are shown in Table 2.

TABLE 2

| | Drive | External Quantum | Brightness Half |
|---|---|---|---|
| Element No. | Voltage (V) | Efficiency (%) | Decay Time (Hour) |
| Element B1 for | 13.5 | 4.7 | >5000 h |
| comparison | | | |
| Element 11 of | 11.4 | 7.5 | >5000 h |
| the invention | | | |
| Element 12 of | 10.7 | 8.1 | >5000 h |
| the invention | | | |
| Element 13 of | 10.1 | 8.3 | >5000 h |
| the invention | | | |

As is clear from the above results, the elements of the invention showed an increased external quantum efficiency, lowered drive voltage and high drive durability which is sufficient for practical use as compared with the comparative element No. B1. The element No. 11 of the invention showed increased external quantum efficiency, and lowered drive voltage. The element No. 12 of the invention which contains a phosphine oxide compound having good electron transportation property in the electron transport layer showed further increased external quantum efficiency, and lowered drive voltage. The element No. 13 of the invention also showed increased external quantum efficiency, and lowered drive voltage. In particular, among the samples of the invention, the element No. 13 showed best performance. That is, it is clear that an unexpectedly excellent improvement in external quantum efficiency and lowered drive voltage are attained, when a light-emitting layer contains a phosphine oxide compound, an electron transport layer between the light-emitting layer and a cathode also contains a phosphine oxide compound, and a hole-blocking layer is disposed between the electron transport layer and the light-emitting layer.

What is claimed is:

1. An organic electroluminescence element comprising at least one organic compound layer comprising a light-emitting layer between a pair of electrodes, wherein the light-emitting layer comprises a host material and a light-emitting material, and further comprises a phosphine oxide compound.

2. The organic electroluminescence element according to claim 1, wherein the phosphine oxide compound has an ionization potential (Ip value) larger than an Ip value of at least one of the host material or the light-emitting material.

3. The organic electroluminescence element according to claim 1, wherein a content of the phosphine oxide compound in the light-emitting layer is from 5% by weight to 50% by weight based on a total solid content of the light-emitting layer.

4. The organic electroluminescence element according to claim 3, wherein the content of the phosphine oxide compound in the light-emitting layer is from 15% by weight to 30% by weight based on the total solid content of the light-emitting layer.

5. The organic electroluminescence element according to claim 1, wherein the phosphine oxide compound is a compound represented by the following formula (I): 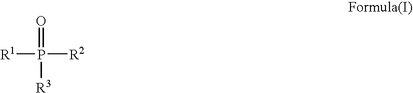
wherein R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

6. The organic electroluminescence element according to claim 5, wherein the phosphine oxide compound represented by the formula (I) is a compound represented by the following formula (II): 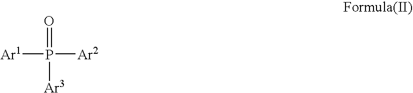
wherein Ar¹, Ar² and Ar³ each independently represent an aryl group or a heterocyclic group.

7. The organic electroluminescence element according to claim 1, wherein the phosphine oxide compound is a compound represented by the following formula (III): 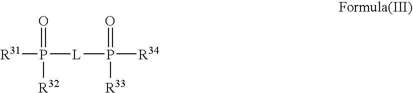
wherein R³¹ to R³⁴ each independently represent an aryl group or a heterocyclic group, and L represents a divalent linking group.

8. The organic electroluminescence element according to claim 1, wherein the organic electroluminescence element further comprises an organic layer comprising a phosphine oxide compound on a cathode side of the light-emitting layer, and a hole-blocking layer between the organic layer and the light-emitting layer.

9. The organic electroluminescence element according to claim 8, wherein the phosphine oxide compound in the organic layer is a compound represented by the following formula (I): 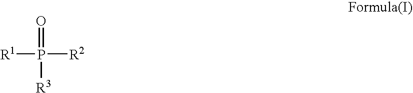
wherein R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

10. The organic electroluminescence element according to claim 9, wherein the phosphine oxide compound represented by the formula (I) is a compound represented by the following formula (II): 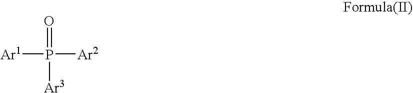
wherein Ar¹, Ar² and Ar³ each independently represent an aryl group or a heterocyclic group.

11. The organic electroluminescence element according to claim 8, wherein the phosphine oxide compound in the organic layer is a compound represented by the following formula (III): 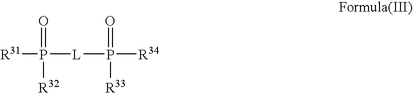
wherein R³¹ to R³⁴ each independently represent an aryl group or a heterocyclic group, and L represents a divalent linking group.
